(19) United States
(12) Patent Application Publication
(10) Pub. No.: US 2020/0294398 A1
(43) Pub. Date: Sep. 17, 2020

(54) PARKING-DEMAND ESTIMATING DEVICE, PARKING-DEMAND ESTIMATING SYSTEM, PARKING-DEMAND ESTIMATING METHOD, AND ON-VEHICLE DEVICE

(71) Applicant: DENSO TEN Limited, Kobe-shi (JP)

(72) Inventor: Azusa NAKA, Kobe-shi (JP)

(73) Assignee: DENSO TEN Limited, Kobe-shi (JP)

(21) Appl. No.: 16/808,895

(22) Filed: Mar. 4, 2020

(30) Foreign Application Priority Data
Mar. 14, 2019 (JP) 2019-047485

(51) Int. Cl. G08G 1/14

(52) U.S. Cl. CPC G08G 1/143; G08G 1/146

(57) ABSTRACT

A parking-demand estimating device includes a processor programmed to (a) collect, from one of vehicles in which on-vehicle devices are provided and via an on-vehicle device of the one vehicle, parking-request operation data and parking-request location data, the parking-request operation data indicating a request operation that requests for parking of the one vehicle, and the parking-request location data indicating a request location in which the request operation is performed and (b) estimate demand for parking of the request location based on the collected parking-request operation data and the collected parking-request location data.

### CROSS-REFERENCE TO RELATED APPLICATION

This application is based upon and claims the benefit of priority of the prior Japanese Patent Application No. 2019-047485, filed on Mar. 14, 2019, the entire contents of which are incorporated herein by reference.

### FIELD

The embodiment discussed herein is directed to a parking-demand estimating device, a parking-demand estimating system, a parking-demand estimating method, and an on-vehicle device.

### BACKGROUND

Conventionally, there has been known a data collecting device that collects road information from on-vehicle devices provided in vehicles. Such a data collecting device selects, on the basis of positional information of vehicles, a vehicle to be a collection target of road information so as to collect road information at a desired location (see, Japanese Laid-open Patent Publication No. 2018-055581, for example).

However, the above-mentioned conventional technology merely collects road information, and does not estimate demand for parking. Specifically, for example, when planning construction of a parking lot, an entrepreneur or the like needs to consider, in order to decide an area of the construction and its scale, to what extent there presents potential demand for parking at the location. Thus, there has been desired a technology capable of estimating demand for parking with high accuracy.

### SUMMARY

A parking-demand estimating device according to one aspect of an embodiment includes a processor programmed to (a) collect, from one of vehicles in which on-vehicle devices are provided and via an on-vehicle device of the one vehicle, parking-request operation data and parking-request location data, the parking-request operation data indicating a request operation that requests for parking of the one vehicle, and the parking-request location data indicating a request location in which the request operation is performed and (b) estimate demand for parking of the request location based on the collected parking-request operation data and the collected parking-request location data.

### BRIEF DESCRIPTION OF DRAWINGS

A more complete appreciation of the disclosed technology and many of the attendant advantages thereof will be readily obtained as the same becomes better understood by reference to the following detailed description when considered in connection with the accompanying drawings, wherein:

FIGS. 1A to 1D are diagrams illustrating the outline of a data collecting system according to an embodiment;

FIG. 2 is a block diagram illustrating a configuration example of the data collecting system according to the embodiment;

FIG. 3 is a diagram illustrating one example of collected data;

FIG. 4A is a diagram illustrating one example of display information including a display mode according to demand for parking;

FIG. 4B is a diagram illustrating a modification of the display information including the display mode according to demand for parking;

FIG. 5 is a flowchart illustrating a processing procedure to be executed by a data collecting device according to the embodiment; and

FIG. 6 is a block diagram illustrating a configuration of a data collecting device according to a modification.

### DESCRIPTION OF EMBODIMENTS

Hereinafter, an embodiment of a parking-demand estimating device, a parking-demand estimating system, a parking-demand estimating method, and an on-vehicle device according to the present application will be described in detail with reference to the accompanying drawings. The present disclosure is not limited to the embodiment described in the following.

As described below, the parking-demand estimating method according to the embodiment is executed by the data collecting device. Thus, the data collecting device according to the embodiment is one example of the parking-demand estimating device, and a data collecting system including the data collecting device is one example of the parking-demand estimating system.

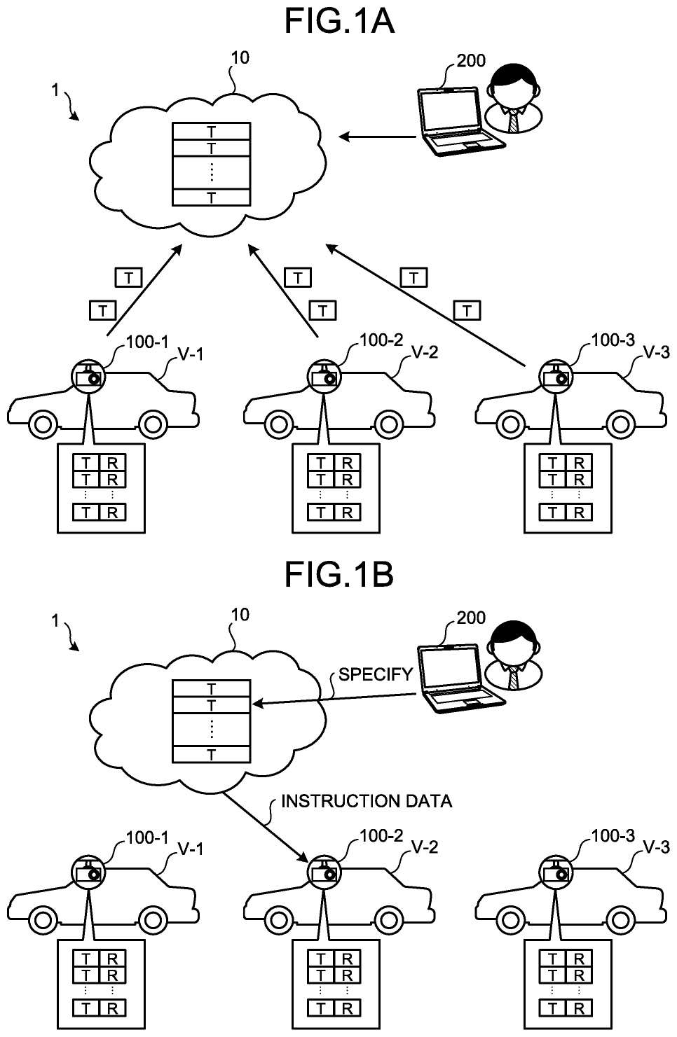

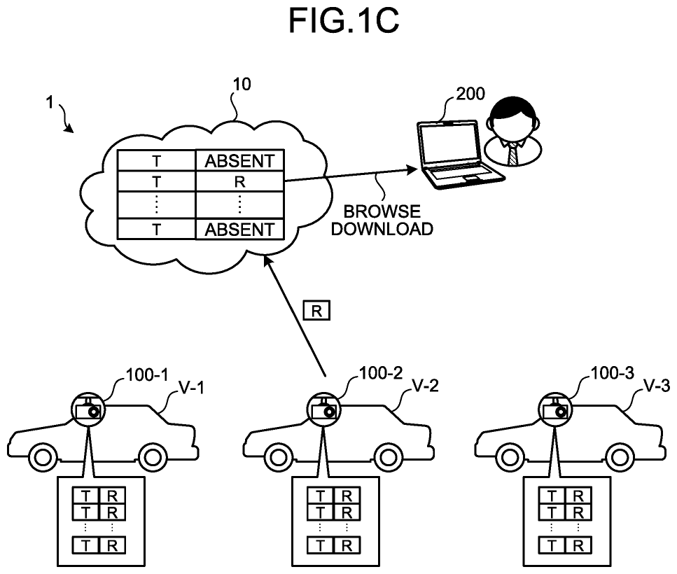

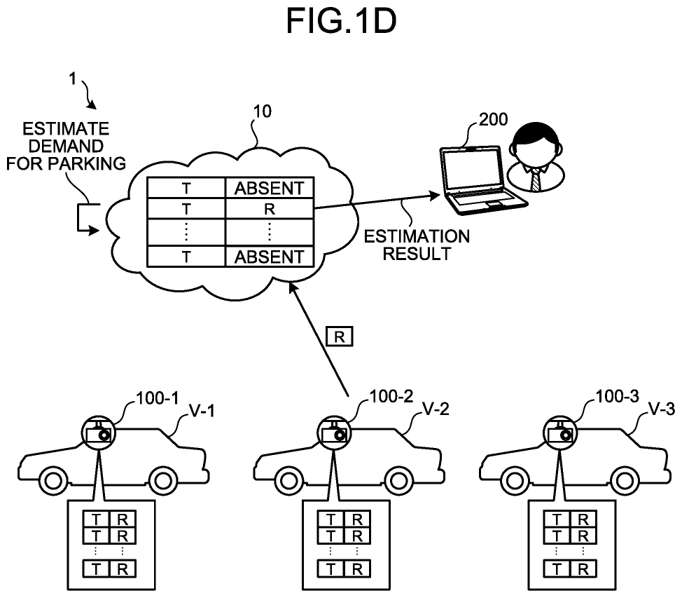

First, the outline of the data collecting system according to the embodiment will be explained with reference to FIGS. 1A to 1D. FIGS. 1A to 1D are diagrams illustrating the outline of the data collecting system according to the embodiment.

As illustrated in FIG. 1A, a data collecting system 1 according to the embodiment includes a data collecting device 10, on-vehicle devices 100-1, 100-2, 100-3 . . . that are respectively provided in vehicles V-1, V-2, V-3 . . . , and a user terminal 200. Hereinafter, when generally indicating a vehicle, it may be referred to as “vehicle V”, and when generally indicating an on-vehicle device, it may be referred to as “on-vehicle device 100”.

The data collecting device 10 is configured as a cloud server that provides cloud services via a network such as the Internet and a mobile telephone network, so as to receive, from a data user, a collection request for data (hereinafter, may be referred to as “vehicle data”) on the vehicles V, and further to collect the vehicle data from the on-vehicle devices 100 on the basis of the received collection request. The data collecting device 10 provides the collected vehicle data to a user, and executes a process for estimating demand for parking on the basis of the vehicle data.

The on-vehicle device 100 is a device including various sensors such as a camera, an acceleration sensor, a Global Positioning System (GPS) sensor, and a drive-source-state detecting sensor; a storage device; and a microcomputer; so as to acquire a collection request that has been received by the data collecting device 10 and further to acquire vehicle data from the vehicle V in response to the collection request.

The above-mentioned camera captures the periphery of the vehicle V, for example. The acceleration sensor detects an acceleration that works on the vehicle V, and the GPS sensor detects a location of the vehicle V. The drive-source-state detecting sensor detects an ON/OFF state of a drive source such as an engine. For example, a dashboard camera may be employed for the on-vehicle device 100.

The on-vehicle device 100 appropriately uploads the acquired vehicle data to the data collecting device 10. When a dashboard camera is used as the on-vehicle device 100 as described above, it is possible to improve efficiency in on-vehicle components provided in the vehicle V. Note that a dashboard camera and the on-vehicle device 100 may be separately configured without using the dashboard camera as the on-vehicle device 100.

The user terminal 200 is a terminal to be used by a data user, such as a laptop-type Personal Computer (PC), a desktop-type PC, a tablet terminal, a Personal Digital Assistant (PDA), a smartphone, and a wearable device that is an information processing terminal having an eye-glasses-type or a watch-type. The user terminal 200 is one example of the terminal device, and the data user is one example of a user.

In the data collecting system 1 according to the embodiment, the data collecting device 10 is capable of collecting vehicle data from the on-vehicle device 100 on the basis of a collection condition specified via the user terminal 200, so as to provide the collected vehicle data to the user terminal 200. Hereinafter, a series of flow until vehicle data is provided to a data user in the data collecting system 1 will be explained with reference to FIGS. 1A to 1C.

As illustrated in FIG. 1A, a data user specifies a collection condition by using the user terminal 200 that is connected to the data collecting device 10.

In this case, the data collecting device 10 generates data for generating tag data T that is added to actual data R (one example of “vehicle data”) to be collected and has a feature as index data to be used in searching for the actual data R and/or in grasping the outline of the actual data R. In other words, the tag data T means meta data obtained by converting the actual data R into meta information. The data for generating the tag data T is generated on the basis of an operation of a data user while using a program and/or data for generation stored in the user terminal 200 or the data collecting device 10.

The specified collection condition and the generated data for generating the tag data T are stored in the data collecting device 10, and are further delivered to the vehicle V to be a data collection target and are stored in the on-vehicle device 100.

Next, each of the on-vehicle devices 100 monitors output data from various sensors, and when an occurrence (namely, event) has occurred that satisfies a stored collection condition, stores the actual data R in a storage device, such as the output data and image data. Each of the on-vehicle devices 100 generates, on the basis of the stored data for generating the tag data T and the actual data R, the tag data T corresponding to the actual data R and stores therein the generated tag data T. Each of the on-vehicle devices 100 uploads the tag data T to the data collecting device 10, and the data collecting device 10 stores therein the tag data T. In this case, the actual data R is not uploaded to the data collecting device 10. In other words, as illustrated in FIG. 1A, the data collecting device 10 is in a state where having stored therein the tag data T alone.

When a data user connects, by using the user terminal 200, to the data collecting device 10 in order to recognize a situation of collection and/or to collect the actual data R, the user terminal 200 displays meta information that is based on the tag data T collected by the data collecting device 10.

As illustrated in FIG. 1B, when the data user specifies, by using the user terminal 200, the tag data T corresponding to the actual data R to be collected, there is transmitted, via the data collecting device 10 to the corresponding on-vehicle device 100, instruction data that specifies the actual data R.

Next, as illustrated in FIG. 1C, the specified actual data R is uploaded from each of the on-vehicle devices 100 to the data collecting device 10, and is further stored in the data collecting device 10. The data user accesses, by using the user terminal 200, the actual data R stored in the data collecting device 10 so as to browse and/or download the actual data R.

In terms of data capacity of the on-vehicle device 100, it is preferable that the actual data R uploaded to the data collecting device 10 and the tag data T corresponding to the uploaded actual data R are deleted from the on-vehicle device 100 after being uploaded to the data collecting device 10.

It is preferable that the tag data T is not data obtained by simply extracting a part of the actual data R, but is converted into meta information to the extent that a data user is able to grasp the outline of the actual data R when the data user sees the tag data T so as to determine whether or not the actual data R is necessary.

As described above, the data collecting device 10 is capable of estimating, on the basis of the vehicle data collected from the on-vehicle devices 100, demand with respect to parking (hereinafter, may be referred to as “demand for parking”).

In more detail of the process for estimating demand for parking, assume that a driver desires to park the vehicle V in a predetermined parking lot, for example. In this case, for example, when the predetermined parking lot is in a full state, the driver often performs a request operation that requests for parking of the vehicle V, such as stopping the vehicle V on a road shoulder near the predetermined parking lot to wait a vacancy in the parking lot, or rounding for another parking lot in the neighborhood.

The above-mentioned request operation is performed caused by a shortage of the parking lot, and thus it can be estimated that there presents a potential demand for parking in the location for which the request operation is performed.

Thus, the data collecting device 10 according to the present embodiment collects parking-request operation data indicating a request operation that requests for parking of a vehicle and parking-request location data indicating a request location in which the request operation is performed, and estimates demand for parking in the request location on the basis of the collected parking-request operation data and the collected parking-request location data.

Details of estimation of the demand for parking will be explained with reference to FIG. 1D. Assume that the above-mentioned collection condition includes various parameters such as a condition to be a trigger of the collection, and a case where a request operation is performed which requests for parking is specified as the condition to be a trigger of the collection, for example. Thus, the on-vehicle device 100 stores therein the actual data R when a request operation is performed and the tag data T corresponding to the actual data R, and the tag data T is further stored in the data collecting device 10.

When a data user specifies the tag data T by using the user terminal 200, the actual data R corresponding to the specified tag data T is uploaded from the on-vehicle device 100 to the data collecting device 10 so as to be collected (see FIG. 1D).

For example, when a data user specifies the tag data T including a predetermined vehicle type and/or the tag data T including a predetermined area, the actual data R on the predetermined vehicle type and/or that on the predetermined area alone is able to be collected.

The actual data R collected by the data collecting device 10 includes parking-request operation data indicating a request operation that requests for parking of the vehicle V, parking-request location data indicating a request location in which the request operation is performed, etc.; however, not limited thereto.

In the data collecting device 10, an estimating process of demand for parking is executed. For example, the data collecting device 10 analyzes the collected actual data R, and when parking-request location data indicating a request location in which a request operation is performed is comparatively concentrated in a predetermined location, estimates that demand for parking is comparatively large in the predetermined location.

As described above, in the present embodiment, collected parking-request operation data and collected parking-request location data are used to estimate demand for parking with high accuracy.

The data collecting device 10 provides, to the user terminal 200, information indicating an estimation result of demand for parking. In the aforementioned, the data collecting device 10 is configured to provide, to the user terminal 200, the information indicating an estimation result; however, not limited thereto. In other words, for example, when a data user is not an entrepreneur that has a plan for parking such as a construction plan for a parking lot, the user terminal 200 or the data collecting device 10 may provide, to a terminal of the entrepreneur, information indicating the estimation result.

Hereinafter, more details of the configuration example of the data collecting system 1 according to the embodiment will be explained.

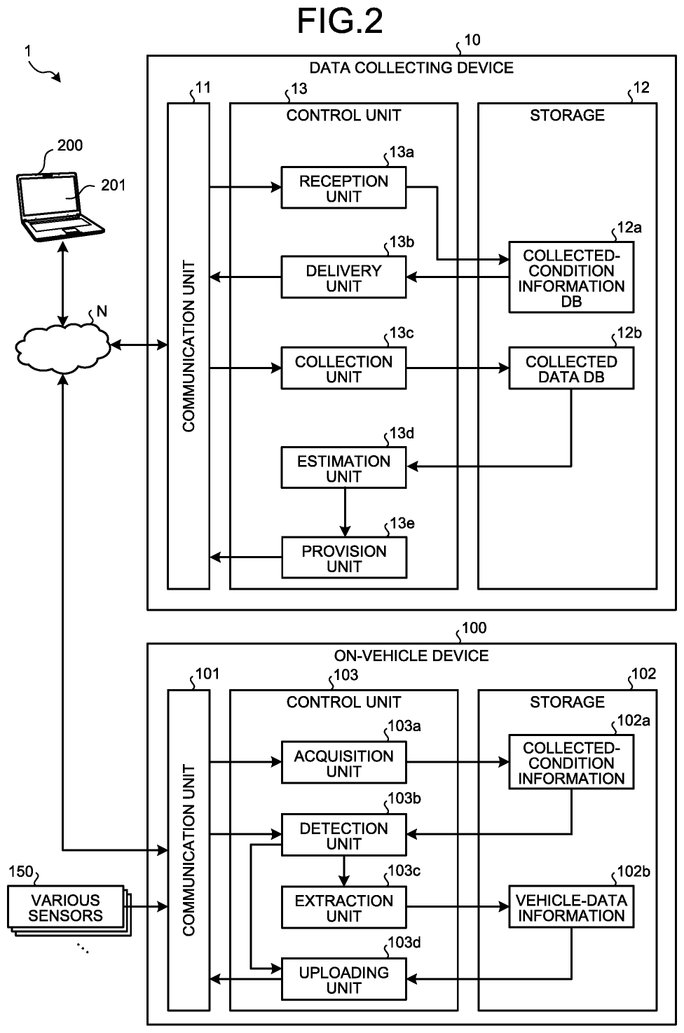

FIG. 2 is a block diagram illustrating a configuration example of the data collecting system 1 according to the embodiment. In FIG. 2, only configuration elements needed for explaining features of the embodiment are illustrated, and a description of common configuration elements is omitted.

FIG. 2 is functionally conceptual, and thus, does not always physically configured as illustrated in the drawings. For example, a specific mode of separation or integration of each apparatus is not limited to that illustrated in the drawings. That is, all or some of the components can be configured by separating or integrating them functionally or physically in any unit, according to various types of loads, the status of use, etc.

In explanation with reference to FIG. 2, explanation of the configuration elements that have already been described may be simplified or omitted.

As illustrated in FIG. 2, the data collecting system 1 according to the embodiment includes the data collecting device 10, the on-vehicle device(s) 100, and the user terminal 200.

First, the data collecting device 10 will be explained. The data collecting device 10 includes a communication unit 11, a storage 12, and a control unit 13.

The communication unit 11 is constituted of a Network Interface Card (NIC), for example. The communication unit 11 is connected to a network N in a wired or wireless manner, and transmits and receives, via the network N, information to and from the on-vehicle device 100 and the user terminal 200.

The storage 12 is constituted of a semiconductor memory element such as a Random Access Memory (RAM) and a flash memory (Flash Memory), or a storage such as a hard disk and an optical disk; and stores, in the example illustrated in FIG. 2, therein a collected-condition information DB 12a and a collected data DB 12b.

Collection conditions specified from the user terminal 200 and received by a reception unit 13a to be mentioned later are accumulated in the collected-condition information DB 12a. In other words, the collected-condition information DB 12a includes past actual results with respect to collection conditions.

A collection condition includes various parameters with respect to collecting of vehicle data. For example, the various parameters include an identifier of the target vehicle V, a type of data to be collected, a condition to be a collection trigger, and a collection time interval. As one example a condition to be a collection trigger, there presents a case where a request operation that requests for parking is performed.

Examples in which a request operation, which requests for parking, is determined to be performed include a case where the vehicle V does not move after a predetermined time interval has elapsed since the vehicle V stopped in a location different from a parking lot, such as a road shoulder of a local road, a case where an engine of the vehicle V is turned on after a predetermined time interval has elapsed since the engine was turned off, a case where the vehicle V is in a rounding state in which the vehicle V is rounding within a predetermined range, and the like; however, not limited thereto.

The above-mentioned predetermined time interval is set to a value that is longer than a time interval during which the vehicle V is stopped due to a reason different from parking, such as waiting for a traffic light; however, not limited thereto, may be set to an arbitrary value. The above-mentioned predetermined range is set to a range in which the vehicle V is estimated to move while a driver is looking for a parking lot; however, not limited thereto, may be set to an arbitrary value.

In the collected data DB 12b, there is accumulated collected data collected from the on-vehicle devices 100 by a collection unit 13c to be mentioned later. In other words, the collected data DB 12b includes past actual results of collected data. The collected data includes the above-mentioned tag data T and the above-mentioned actual data R.

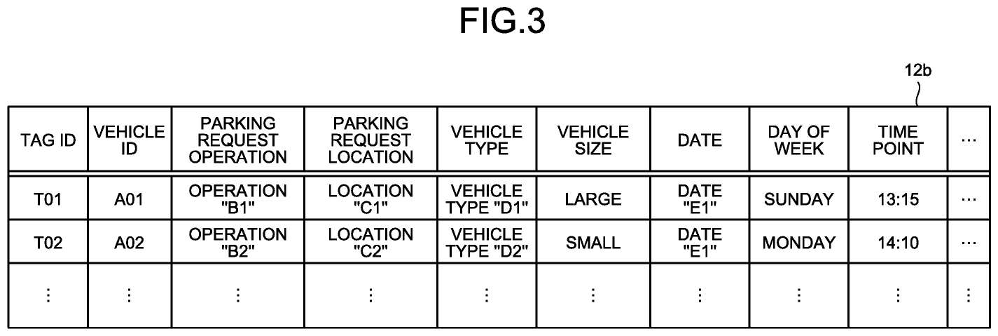

Collected data stored in the collected data DB 12b will be explained with reference to FIG. 3. FIG. 3 is a diagram illustrating one example of collected data. As illustrated in FIG. 3, collected data includes items such as “tag ID”, “vehicle ID”, “parking request operation”, “parking request location”, “vehicle type”, “vehicle size”, “date”, “day of week”, and “time point”.

“Tag ID” is identification information that identifies the tag data T. “Vehicle ID” is identification information that identifies the vehicle V. “Parking request operation” is information indicating contents of a request operation that requests for parking. In the example illustrated in FIG. 3, for convenience of explanation, “parking request operation” may be abstractly referred to as “operation B1”, however, the “operation B1” is assumed to store therein concrete information. Hereinafter, other information may be abstractly referred.

“Parking request location” is information that indicates a request location in which a request operation that requests for parking is performed. “Vehicle type” is information indicating a vehicle type of the vehicle V. The vehicle type may be any kind of information as long as it indicates a type of the vehicle V such as a car, a commercial vehicle, a bus, a taxi, and a rental car. “Vehicle size” is information that indicates a size of the vehicle V.

“Date” is information indicating a date when a request operation is performed, “day of week” is information indicating the day of the week on which a request operation is performed, and “time point” is information indicating a time point at which a request operation is performed. Note that the collected data may include, in addition to or instead of the above-mentioned “date”, information on “season” and the like.

In the example illustrated in FIG. 3, data identified by tag ID “T1” indicates that a vehicle ID is “A01”, a parking request operation is “operation B1”, a parking request location is “location C1”, a vehicle type is “vehicle type D1”, a vehicle size is “large”, a date is “date E1”, the day of the week is “Sunday”, and a time point is “13:15”.

Returning to the explanation of FIG. 2, the control unit 13 is a controller, and, for example, a Central Processing Unit (CPU), a Micro Processing Unit (MPU), and the like execute, by using RAM as a work region, various programs stored in a storage device in the data collecting device 10 so as to realize the control unit 13. The control unit 13 is realized by using an integrated circuit such as an Application Specific Integrated Circuit (ASIC) and a Field Programmable Gate Array (FPGA).

The control unit 13 includes the reception unit 13a, a delivery unit 13b, the collection unit 13c, an estimation unit 13d, and a provision unit 13e so as to realize or execute functions and actions of the following information processing.

The reception unit 13a receives, via the communication unit 11, a collection condition specified, by a data user, from the user terminal 200, and informs the delivery unit 13b of the received collection condition. The reception unit 13a stores, in the collected-condition information DB 12a, the collection condition specified by the data user.

The delivery unit 13b is stored in the collected-condition information DB 12a, and delivers, to the vehicle V to be a target vehicle, a collection condition specified by a data user via the communication unit 11 in file format, for example.

The collection unit 13c collects, via the communication unit 11, the tag data T and the actual data R that are vehicle data acquired on the basis of the collection condition delivered from the delivery unit 13b and are uploaded from the on-vehicle device 100, and accumulates, as collected data, the data in the collected data DB 12b.

For example, the collection unit 13c collects, for example, parking-request operation data indicating a request operation that requests for parking of the vehicle V, parking-request location data indicating a request location in which a request operation has been performed, data indicating a vehicle type, data indicating a size of the vehicle V, and data indicating a date, the day of the week, and a time point.

Moreover, for example, the collection unit 13c may collect, as the parking-request operation data, a request operation that is performed in a predetermined location (for example, road shoulder of local road) different from a parking lot. Thus, the collection unit 13c is capable of collecting parking-request operation data with high accuracy.

In other words, a request operation includes a stopping operation of the vehicle V, and the stopping operation of the vehicle V in a parking lot includes, for example, a stopping operation waiting for completion of parking of another vehicle, and a stopping operation waiting for ticketing of a parking stub or for paying a fee. Thus, there presents possibility that a stopping operation waiting for completion of parking of another vehicle may be erroneously determined that a request operation is performed from the vehicle V that is not able to be parked in a parking lot, as a result, parking-request operation data is not collected with high accuracy.

Therefore, the collection unit 13c according to the present embodiment collects, as parking-request operation data, a request operation that is performed in a predetermined location different from a parking lot so as to prevent the above-mentioned erroneous determination, so that it is possible to collect parking-request operation data with high accuracy.

For example, the collection unit 13c may collect, as parking-request operation data, a rounding state in which the vehicle V is rounding within a predetermined range. In other words, it can be estimated that a parking lot is in a full state, and thus the vehicle V rounding within a predetermined range is looking for another parking lot in the neighborhood, for example.

Thus, the collection unit 13c according to the present embodiment determines that the vehicle V in the above-mentioned rounding state is performing a request operation, and thus collects the rounding state as parking-request operation data. Thus, the collection unit 13c is capable of collecting parking-request operation data with high accuracy.

The estimation unit 13d estimates demand for parking in a request location on the basis of the collected parking-request operation data, the collected parking-request location data, and the like.

For example, in such a case where parking-request location data indicating a request location in which a request operation has been performed are comparatively concentrated in a predetermined location, the estimation unit 13d estimates that demand for parking in the predetermined location is comparatively large. Specifically, when parking-request location data is equal to or more than a predetermined value in a predetermined location, the estimation unit 13d estimates that demand for parking is comparatively large; however, not limited thereto.

On the other hand, in such a case where parking-request location data are not comparatively concentrated in a predetermined location, the estimation unit 13d estimates that demand for parking in the predetermined location is comparatively small. Specifically, when parking-request location data is less than a predetermined value in a predetermined location, the estimation unit 13d estimates that demand for parking is comparatively small; however, not limited thereto.

As described above, the estimation unit 13d according to the present embodiment uses the collected parking-request operation data and the collected parking-request location data, so that it is possible to estimate demand for parking with high accuracy.

The estimation unit 13d is capable of estimating, on the basis of “vehicle type” of the collected data, demand for parking with respect to a specific vehicle type, for example. For example, when comparatively a lot of “commercial vehicle” is included in a vehicle type of the collected data, the estimation unit 13d is capable of estimating that demand for parking of a commercial vehicle is comparatively large. Thus, for example, an entrepreneur or the like is able to plan, on the basis of a result that demand for parking of a commercial vehicle is comparatively large, construction of a parking lot in which many commercial vehicles can be parked.

For example, the estimation unit 13d is capable of estimating, on the basis of “vehicle size” in the collected data, demand for parking with respect to a size of the vehicle V. For example, when comparatively a lot of “large” is included in a vehicle size of the collected data, the estimation unit 13d is capable of estimating that demand for parking of a large-size vehicle is comparatively large. Thus, for example, an entrepreneur or the like is able to plan, on the basis of a result that demand for parking of a large-size vehicle is comparatively large, construction of a parking lot in which many large-size vehicles can be parked.

For example, the estimation unit 13d is capable of estimating, on the basis of “date”, “day of week”, “time point”, etc. in the collected data, demand for parking with respect to a date and hour of parking. For example, when comparatively a lot of “Sunday” is included in the day of the week of the collected data, the estimation unit 13d is capable of estimating that demand for parking on Sunday is comparatively large. Thus, for example, an entrepreneur or the like is able to plan, on the basis of a result that demand for parking on Sunday is comparatively large, construction of a parking lot whose parking fee on Sunday is set to higher (or lower) than that on other days of the week.

As described above, the estimation unit 13d according to the present embodiment estimates demand for parking on the basis of various collected data such as parking-request operation data, parking-request location data, a vehicle type, a vehicle size, and a date, the day of the week, and a time point of parking, so that it is possible to improve estimation accuracy. Thus, it is possible to use an estimation result having a high accuracy in planning construction and in setting a fee of a parking lot, for example.

The provision unit 13e provides, to the user terminal 200 or a terminal (not illustrated) of an entrepreneur or the like, information indicating an estimation result of demand for parking obtained by the estimation unit 13d. Moreover, the provision unit 13e may provide, as information indicating an estimation result, display information that includes a display mode according to the estimated demand for parking.

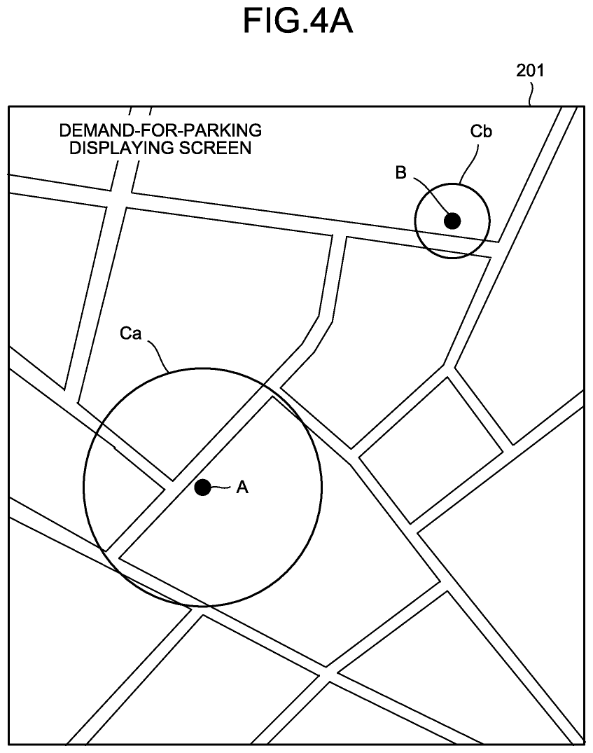

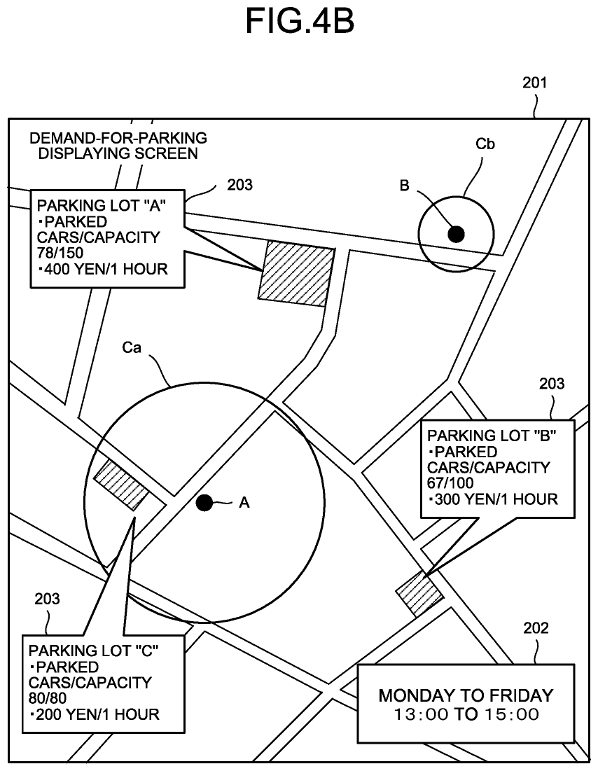

Herein, the display information will be explained, which includes a display mode according to the estimated demand for parking with reference to FIG. 4A. FIG. 4A is a diagram illustrating one example of the display information including a display mode according to demand for parking. In FIG. 4A, a screen 201 (see FIG. 2) of the user terminal 200 is illustrated, which is displayed by provided display information.

As illustrated in FIG. 4A, for example, when an estimation result in a location A indicates that demand for parking is comparatively large, the provision unit 13e provides display information containing a mode that displays, on a map, a circle Ca indicating a degree of demand for parking so that the circle Ca encloses the location A. A size of the circle Ca is changed in accordance with the degree of demand for parking. In other words, demand for parking of the location A is comparatively large, and thus the circle Ca is accordingly comparatively large.

For example, when an estimation result in a location B indicates that demand for parking is comparatively small, the provision unit 13e provides display information containing a mode that displays, on a map, a comparatively small circle Cb so that the circle Cb encloses the location B. Thus, a location whose demand for parking is large or small is able to be easily recognized.

In the aforementioned, the display information have been explained to contain modes that display, on a map, the circles Ca and Cb; however, not limited thereto. In other words, display information may contain another mode, for example, a map is mesh-patterned and a color of a location (zone) having a large demand for parking and that having a small demand for parking are different from each other, a display mode is changed in accordance with a change in a date and hour of parking.

The display mode according to demand for parking, which is illustrated in FIG. 4A, is merely one example, and not limited thereto. FIG. 4B is a diagram illustrating a modification of the display information including the display mode according to demand for parking.

For example, the estimation unit 13d (see FIG. 2) accumulates, processes, and stratifies parking-request operation data, parking-request location data, and the like for each time zone, each day of week, etc. on the basis of “date”, “day of week”, “time point”, etc. of collected data, so as to estimate the stratified demand for parking. As illustrated in FIG. 4B, the provision unit 13e (see FIG. 2) may provide a display mode according to the stratified demand for parking into time zones and/or the days of the week. Note that in the example illustrated in FIG. 4B, information on a time zone and/or the day of the week corresponding to displayed demand for parking is displayed in a display field 202.

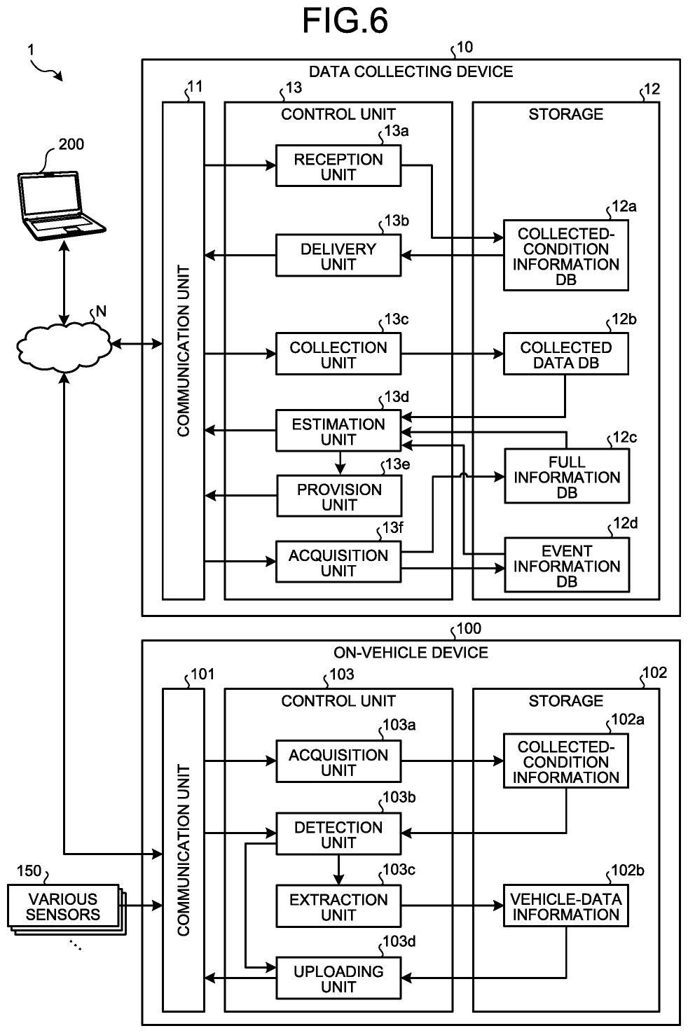

For example, an acquisition unit 13f (see FIG. 6) may acquire, from an external server, peripheral-parking-lot information (for example, locations of parking lots, capacities, present numbers of parking vehicles, parking fees, etc.) on parking lots near a request location. As illustrated in FIG. 4B, the provision unit 13e (see FIG. 2) may provide the peripheral-parking-lot information as a part of the display mode according to demand for parking. In the example illustrated in FIG. 4B, peripheral-parking-lot information is displayed in display fields 203.

Thus, for example, a data user (user) is able to grasp demand for parking lot obtained by taking into account the demand for parking lot stratified into time zones and the days of the week, and peripheral parking lot information, so that it is possible to easily obtain information that is useful for considering adequacy of construction of a parking lot, deciding its appropriate scale, and setting its parking fee.

In the aforementioned, the data collecting device 10 has been explained to accumulate and process the collected data; however, not limited thereto, the user terminal 200 may accumulate and process the collected data.

Returning to FIG. 2, the on-vehicle device 100 will be explained. The on-vehicle device 100 includes a communication unit 101, a storage 102, and a control unit 103. As described above, various sensors 150 such as a camera, an acceleration sensor, a GPS sensor, and a drive-source-state detecting sensor are connected to the on-vehicle device 100.

Similarly to the communication unit 11, the communication unit 101 is realized by using an NIC, for example. The communication unit 101 is connected to the network N in a wireless manner, and transmits and receives, via the network N, information to and from the data collecting device 10. The communication unit 101 receives data output from the various sensors 150.

Similarly to the storage 12, the storage 102 is realized by using a semiconductor memory element such as a RAM and a flash memory, or a storage such as a hard disk and an optical disk, and the example illustrated in FIG. 2 stores therein collected-condition information 102a and vehicle-data information 102b.

The collected-condition information 102a is information containing a collection condition delivered from the data collecting device 10. The vehicle-data information 102b is information containing vehicle data extracted by an extraction unit 103c to be mentioned later. The vehicle data contains the above-mentioned tag data T and the above-mentioned actual data R. The actual data R contains parking-request operation data, parking-request location data, and the like.

Similarly to the control unit 13, the control unit 103 is a controller, and a CPU, an MPU, or the like executes, by using a RAM as a work region, various programs stored in a storage device in the on-vehicle device 100 to realize the control unit 103, for example. The control unit 103 may be realized by using an integrated circuit such as an ASIC and an FPGA.

The control unit 103 includes an acquisition unit 103a, a detection unit 103b, the extraction unit 103c, and an uploading unit 103d, so as to realize or execute functions and actions of the following information processing.

The acquisition unit 103a acquires a collection condition delivered from the data collecting device 10, and stores the delivered collection condition in the collected-condition information 102a. The detection unit 103b monitors output data from the various sensors 150, and detects an occurrence of an event to be a trigger in the collection condition.

For example, when detecting an occurrence of an event to be a trigger for extracting vehicle data in the collection condition (herein, when request operation that requests for parking is performed), the detection unit 103b causes the extraction unit 103c to extract vehicle data. For example, when detecting an occurrence of an event to be a trigger for uploading vehicle data to the data collecting device 10 in the collection condition, the detection unit 103b causes the uploading unit 103d to upload the vehicle data.

When the detection unit 103b detects an occurrence of a trigger for extracting vehicle data, the extraction unit 103c extracts vehicle data that is based on output data from the various sensors 150, and stores the extracted vehicle data in the vehicle-data information 102b. When the detection unit 103b detects an occurrence of a trigger for stopping extraction of vehicle data, the extraction unit 103c stops extraction of vehicle data.

When the detection unit 103b detects an occurrence of a trigger for uploading vehicle data, the uploading unit 103d uploads, to the data collecting device 10, vehicle data (for example, parking-request operation data, parking-request location data, etc.) having been stored in the vehicle-data information 102b. Note that the uploading unit 103d is one example of a transmitting unit.

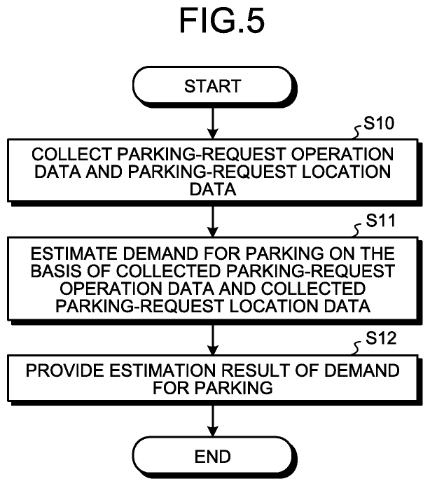

Next, a processing procedure to be executed by the data collecting device 10 will be explained with reference to FIG. 5. FIG. 5 is a flowchart illustrating a processing procedure to be executed by the data collecting device 10 according to the embodiment, specifically, a flowchart illustrating a processing procedure for estimating demand for parking and the like, which is executed by the data collecting device 10.

As illustrated in FIG. 5, the control unit 13 of the data collecting device 10 collects, from the on-vehicle device 100 provided in each of the vehicles V, parking-request operation data indicating a request operation that requests for parking of the corresponding vehicle V, and parking-request location data indicating a request location in which the request operation is performed (Step S10).

Subsequently, the control unit 13 estimates demand for parking at the request location on the basis of the collected parking-request operation data and the collected parking-request location data (Step S11). The control unit 13 provides, to the user terminal 200 and/or a terminal of an entrepreneur, for example, information indicating an estimation result of the demand for parking (Step S12).

As described above, the data collecting device 10 (one example of parking-demand estimating device) according to the embodiment includes the collection unit 13c and the estimation unit 13d. The collection unit 13c collects, from one of the vehicles V in which the on-vehicle devices 100 are provided and via the on-vehicle device 100 of the one vehicle V, parking-request operation data and parking-request location data. The parking-request operation data indicates a request operation that requests for parking of the one vehicle V, and the parking-request location data indicates a request location in which the request operation is performed. The estimation unit 13d estimates demand for parking of the request location on the basis of the parking-request operation data and the parking-request location data that are collected by the collection unit 13c. Thus, it is possible to estimate the demand for parking with high accuracy.

In the aforementioned, the data collecting device 10 has been explained to estimate demand for parking on the basis of the parking-request operation data and the parking-request location data, not limited thereto, the demand for parking may be estimated in additional consideration of another-type data, for example. This point will be explained with reference to FIG. 6. FIG. 6 is a block diagram illustrating a configuration of the data collecting device 10 according to a modification.

As illustrated in FIG. 6, the control unit 13 of the data collecting device 10 according to the modification includes the acquisition unit 13f. The storage 12 stores therein a full information DB 12c and an event information DB 12d.

The acquisition unit 13f acquires full information that indicates a parking lot near a request location is full. For example, the acquisition unit 13f acquires the full information from an external server that manages the parking lot; however, not limited thereto. The acquisition unit 13f stores the acquired full information in the full information DB 12c.

The estimation unit 13d estimates demand for parking on the basis of the full information. For example, when parking-request location data is comparatively concentrated around a full-state parking lot included in the full information, the estimation unit 13d is capable of estimating that there presents, around the parking lot, demand for parking far exceeding a parking capacity of the parking lot.

As described above, when using the full information, the estimation unit 13d is capable of estimating, with high accuracy, that demand for parking around the parking lot is comparatively large. For example, an entrepreneur or the like is able to plan, on the basis of an estimation result that demand for parking around a full-state parking lot is comparatively large, an expansion of the full-state parking lot and/or a construction of a parking lot near the full-state parking lot.

The acquisition unit 13f acquires event information on an event held around a request location. The event information contains information on, not limited thereto, a concert, a theatrical performance, and a sports match.

For example, the acquisition unit 13f acquires event information from, not limited thereto, an external server (not illustrated). The acquisition unit 13f stores the acquired event information in the event information DB 12d.

The estimation unit 13d estimates demand for parking on the basis of the event information. For example, in a case where parking-request location data is comparatively concentrated in a date and hour when an event contained in the event information is held, the estimation unit 13d is capable of estimating that demand for parking becomes comparatively large due to the event.

As described above, when using event information, the estimation unit 13d is capable of estimating a reason that the demand for parking becomes comparatively large. For example, an entrepreneur or the like is able to arrange, on the basis of an estimation result that demand for parking becomes comparatively large due to an event, a plan for preliminary increasing (or decreasing) a parking fee of a nearby parking lot to be higher than that in a case where the event is not held.

The collection unit 13c may further collect, from the on-vehicle device 100, occupant data on an occupant of each of the vehicles V. The occupant data may contain, for example, the number of occupants, their genders, age strata indicating whether they are adults or children. The collection unit 13c may collect the occupant data by analyzing a captured image of a camera, or may collect the occupant data from an output from a sensor such as a seat occupancy sensor; however, not limited thereto.

The estimation unit 13d estimates demand for parking on the basis of the collected occupant data. Thus, for example, the estimation unit 13d is capable of estimating, with high accuracy, that demand for parking becomes comparatively large due to the above-mentioned event.

In other words, for example, when the event is for children and occupant data of the vehicle V that performs a request operation contains a child, the estimation unit 13d is capable of estimating that the request operation is performed for going to the event by the vehicle V. As described above, when using the occupant data, the estimation unit 13d is capable of estimating, with high accuracy, that demand for parking becomes comparatively large due to the event.

Moreover, when using the occupant data, the estimation unit 13 is capable of estimating demand for parking in association with the occupant data. Thus, for example, an entrepreneur or the like is able to construct, in accordance with the occupant data, a building near a location whose demand for parking is estimated to be comparatively large. Specifically, for example, when occupant data containing many women is associated with demand for parking, an entrepreneur or the like is able to arrange a plan that a building to be constructed near a location, whose demand for parking is estimated to be comparatively large, is used as a store intended for women.

The acquisition unit 13f may acquire behavior information on a behavior of an occupant of the vehicle V after parking, and the estimation unit 13d may estimate demand for parking on the basis of the acquired behavior information. The acquisition unit 13f may acquire the behavior information from a terminal (for example, not-illustrated smartphone) of an occupant or an external server; however, not limited thereto.

As described above, when using the behavior information on a behavior of an occupant after parking, the estimation unit 13d is capable of estimating a reason that demand for parking becomes comparatively large. For example, when the behavior information contains many pieces of information on moving to a store X, the estimation unit 13d is capable of estimating that demand for parking becomes comparatively large because many people visit the store X. Thus, an entrepreneur or the like is able to arrange a plan for constructing a parking lot for the store X, for example.

In the above-mentioned modification, the estimation unit 13d has been explained to estimate demand for parking by using the full information, the event information, and the behavior information acquired by the acquisition unit 13f; however, not limited thereto. The estimation unit 13d may estimate the demand for parking by using a part of the full information, the event information, and the behavior information.

Additional advantages and modifications will readily occur to those skilled in the art. Therefore, the invention in its broader aspects is not limited to the specific details and representative embodiment shown and described herein. Accordingly, various modifications may be made without departing from the spirit or scope of the general inventive concept as defined by the appended claims and their equivalents.

What is claimed is:

1. A parking-demand estimating device comprising:
a processor programmed to:
collect, from one of vehicles in which on-vehicle devices are provided and via an on-vehicle device of the one vehicle, parking-request operation data and parking-request location data, the parking-request operation data indicating a request operation that requests for parking of the one vehicle, and the parking-request location data indicating a request location in which the request operation is performed; and
estimate demand for parking of the request location based on the collected parking-request operation data and the collected parking-request location data.

2. The parking-demand estimating device according to claim 1, wherein
the processor is further programmed to:
collect, as the parking-request operation data, a request operation performed in a predetermined location that is different from a parking lot.

3. The parking-demand estimating device according to claim 1, wherein
the processor is further programmed to:
collect, as the parking-request operation data, a rounding state in which the one vehicle is rounding within a predetermined range.

4. The parking-demand estimating device according to claim 1, wherein
the processor is further programmed to:
acquire full information indicating that a parking lot near the request location is full; and
estimate the demand for parking based on the acquired full information.

5. The parking-demand estimating device according to claim 1, wherein
the processor is further programmed to:
acquire event information on an event held around the request location; and
estimate the demand for parking based on the acquired event information.

6. The parking-demand estimating device according to claim 1, wherein
the processor is further programmed to:
collect occupant data on an occupant of the one vehicle; and
estimate the demand for parking based on the collected occupant data.

7. The parking-demand estimating device according to claim 1, wherein
the processor is further programmed to:
acquire behavior information on a behavior of an occupant after parking of the one vehicle; and
estimate the demand for parking based on the acquired behavior information.

8. The parking-demand estimating device according to claim 1, wherein
the processor is further programmed to:
provide display information that contains a display mode according to the estimated demand for parking.

9. A parking-demand estimating system comprising:
the parking-demand estimating device according to claim 1;
an on-vehicle device that transmits data to the parking-demand estimating device; and
a terminal device that acquires data on the demand for parking estimated by the parking-demand estimating device.

10. A parking-demand estimating method comprising:
collecting, from one of vehicles in which on-vehicle devices are provided and via an on-vehicle device of the one vehicle, parking-request operation data and parking-request location data, the parking-request operation data indicating a request operation that requests for parking of the one vehicle, and the parking-request location data indicating a request location in which the request operation is performed; and
estimating demand for parking of the request location based on the parking-request operation data and the parking-request location data that are collected in the collecting.

11. An on-vehicle device comprising:
a processor programmed to:
extract parking-request operation data and parking-request location data, the parking-request operation data indicating a request operation that requests for parking of a vehicle, and the parking-request location data indicating a request location in which the request operation is performed; and
transmit, as data for estimating demand for parking of the request location, the extracted parking-request operation data and the extracted parking-request location data.
